(19) United States
(12) Patent Application Publication
(10) Pub. No.: US 2008/0302206 A1
(43) Pub. Date: Dec. 11, 2008

(54) Handle control knob with automatic return for hydraulic power unit

(76) Inventor: Harry H. Arzouman, Corona Del Mar, CA (US)

Correspondence Address: Roger C. Turner, Suite 306, 280 Cagney Ln., Newport Beach, CA, 92663, US

(21) Appl. No.: 11/810,454

(22) Filed: Jun. 6, 2007

(51) Int. Cl. G05G 1/10

(52) U.S. Cl. 74/553

(57) ABSTRACT

A rotatable control knob with automatic return, controls a valve of a hydraulic cylinder on a jack-stand power unit or a floor jack. The power unit includes a frame having the hydraulic cylinder secured at the rearward end. The control valve is rotatable in one direction for closing the valve to extend the cylinder, and is rotatable in a counter-direction for opening the valve to retract the cylinder. A tubular handle with a T-bar hand grip extends rearward and upwardly from the frame, with the control knob extending from the T-bar hand grip, and connected to a control shaft extending through the tubular handle to the control valve of the cylinder. The control knob automatic return, includes a torsion spring having one end fixed to the control knob and the other end fixed to the tubular handle. The control knob can be rotated in the counter-direction to open the valve; and when the knob is released, the torsion spring automatically forces the knob and shaft to rotate back to the original position to close the valve.

### BACKGROUND OF THE INVENTION

The invention relates to a hydraulic jack-stand power unit of a two part jacking system, and for a hydraulic floor jack, for lifting and supporting a corner of an automobile; particularly to an improved handle control knob for controlling the valve of the hydraulic cylinder. The inventor of the present invention is a pioneer of the two part jacking system and holds numerous patents for two part jacking systems, some of which are described below.

Briefly, the commercial two part jacking system consists of a mobile power unit and a set of separate mechanical jack stands. Examples of the two part jacking system and mobile power unit are described in detail in Re. 32,715; U.S. Pat. Nos. 4,589,630 and 6,986,503. Some examples of the jack stands are described in detail in U.S. Pat. Nos. 4,553,727; 5,110,089; 5,183,235 and 5,379,974. The stands are capable of being vertically extended and retracted from the garage floor or road surface and, when extended, can be locked in place at a desired position by a ratchet and pawl assembly. The power unit has a wheeled mobile chassis adapted to carry a plurality of the jack stands, and has a pair of lift arms adapted to mate with the outermost jack stand for placement and removal.

In use, the commercial mobile power unit is operated from its handle. It is maneuvered under a vehicle to place a jack stand in a desired location for lifting and supporting the vehicle. The power unit is activated from the handle, and the jack stand is then extended vertically to the desired height, thus lifting the vehicle on the stand. By operating the controls at the end of the handle, the operator can cause the power unit to disengage from the stand, and the stand will remain locked in its extended supporting position under the vehicle.

After the stand is raised and locked in place supporting the vehicle, or other load, in an elevated position, the power unit lift arms are lowered and the power unit is disengaged from the stand and pulled away, leaving the stand in position supporting the load. Another jack stand, carried within the chassis, is automatically transferred to the forward end the chassis for placement at another desired location of the vehicle or for use in lifting and supporting another vehicle.

To lower the vehicle and remove the stand, the power unit is maneuvered to re-engage with the stand. The engagement causes any existing jack stands carried within the chassis to be automatically transferred rearward within the chassis. By manually operating a control at the end of the handle, the operator can cause the power unit to re-engage with the stand, and to disengage the ratchet locking mechanism of the stand, and to lower the stand to its original position. The power unit remains engaged with the stand and can be pulled away from the vehicle with the stand carried within the chassis.

The original commercial power units were adapted to carry up to four jack stands within the chassis. Additional jack stands could be acquired to reload the power unit, so that a single power unit could be utilized to efficiently place and actuate numerous jack stands. It was found that many commercial users would utilize all of their available jack stands, and the power unit was thereafter useless until another jack stand was available to be extracted and reused. The present inventor developed a two-position lift bridge (and also an automatic-slide-forward bridge) that adapted the power unit to function as a load-lifting jack to more fully utilize the power unit. This invention is illustrated in U.S. Pat. No. 6,779,780 entitled Lift Bridge For Use With a Power Unit and a Load Lifting Jack, along with several other patents related to additional features of the lifting system.

In the continuous development and manufacture of these lifting devices, unique improvements often result in additional inventions. It was discovered that at the end of a lifting project, the operator would open the control valve knob to lower the jack, and usually not close the control knob; at a subsequent next project, the operator usually does not check the position of the knob and wastes time makings several handle pumps with the valve in the open position, until this was recognized and corrected to initiate the new lifting project. More importantly, it was discovered that when the jack was in the raised position, the control knob could be accidentally bumped and rotated to prematurely release the hydraulic valve and unexpectedly lower the load.

In view of the foregoing situations, it is an object of the present invention to provide a handle control knob for a hydraulic control valve of power unit, and for a hydraulic floor jack, that is always biased in the closed, operable position.

It is another object to provide a handle control knob for a hydraulic floor jack control valve that can be manually rotated in one direction to open the valve, and when the knob is released, to automatically rotate in the other direction to safely return to close the valve.

### SUMMARY OF THE INVENTION

The foregoing objects are accomplished by the present invention of a rotatable control knob with automatic return, for a control valve of a hydraulic cylinder, for use with a jack-stand power unit, and for use with a hydraulic floor jack.

The jack-stand power unit and the hydraulic floor jack each includes a generally rectangular frame having a forward end and a rearward end and the hydraulic cylinder is secured at the rearward end. The cylinder includes at least one actuator piston and the control valve is rotatable in one direction for closing the valve to pump the actuator and extend the cylinder, and is rotatable in a counter-direction for opening the valve to retract the cylinder.

The rearward end of the frame includes a tubular handle extending rearward and upwardly with a T-bar hand grip at the proximal end thereof, with the rotatable control knob extending from the T-bar hand grip. The control knob has a hub connected to a control shaft extending from the control knob through the tubular handle to the control valve of the cylinder. A rotation of the control knob rotates the control valve, wherein the automatic return includes means for biasing the control knob (and thus the control shaft and the control valve) into the closed position.

The rotatable control knob automatic return, generally includes a torsion spring having one end fixed to the hub of the control knob and the other end fixed to the tubular handle. The knob can be rotated, or accidentally bumped, into the counter-direction to open the valve; and when the knob is released, the torsion spring automatically forces the knob and shaft to rotate back to the original position to close the valve. When the jack is supporting a load, the immediate correction to an accidental bump releasing the control knob is a significant safety feature.

A preferred embodiment includes a cylindrical wire torsion spring having an upper coil with the end fixed to the control knob and a lower coil with the end fixed to the tubular handle.

Another embodiment includes a spiral-leaf-clock-type torsion spring having an inner end fixed to the tubular handle and an outer end fixed to the control knob.

Another embodiment includes a tension spring having an outer end connected within the T-bar hand grip of the tubular handle, and having a flexible cable connected to an inner end of the spring and having the other end of the cable connected to the control shaft. A rotating of the knob opens the valve, and winds the cable on the control shaft; and when the knob is released, the tension spring automatically forces the knob and shaft to rotate back to close the valve.

### BRIEF DESCRIPTION OF THE DRAWINGS

While the novel features of the invention are set forth in the appended claims, the invention will be better understood along with other features thereof from the following detailed description taken in conjunction with the drawings, in which:

FIG. 1 is top-front perspective view of a power unit carrying two jack stands;

FIG. 2 is a view similar to FIG. 1, without the jack-stands, and with the rear cover exploded to show more of the hydraulic cylinder;

FIG. 3 is a top right-side perspective view of the upper end of the handle of the power unit;

FIG. 4 is a right side elevation view of the upper end of the handle of the power unit showing a preferred embodiment of the present invention;

FIG. 5 a front elevation view of the upper end of the handle of the power unit of a preferred embodiment (with the torsion spring in phantom) of the present invention;

FIG. 6 is a sectional view taken along 6-6 of FIG. 5;

FIG. 7 side elevation view of the upper end of the handle of the power unit showing a second embodiment of the present invention;

FIG. 8 is a sectional view taken along 8-8 of FIG; 7;

FIG. 9 is a front perspective view of the second embodiment of the present invention;

FIG. 10 a plan view of the upper end of the handle of the power unit illustrating a third embodiment (in phantom lines) of the present invention; and

FIG. 11 is view similar to FIG. 10 with the knob rotated about one-quarter turn, to release the hydraulic valve.

### DETAILED DESCRIPTION OF THE INVENTION

The figures and the following specification may describe and define several distinctive inventions that are interrelated within a lifting and supporting system, and may be included in patents (or pending applications) having distinctive sets of claims directed to the respective invention. Also, the improved power unit and jack stands are discussed and described in terms of an automotive lifting system, but it should be understood that the system is not limited to automotive uses and can be utilized for lifting and supporting any type of load. The present invention is described in terms of a two-part system, but the device directed to the handle control knob of the jack-stand power unit is also applicable to a handle control knob of a conventional hydraulic floor jack.

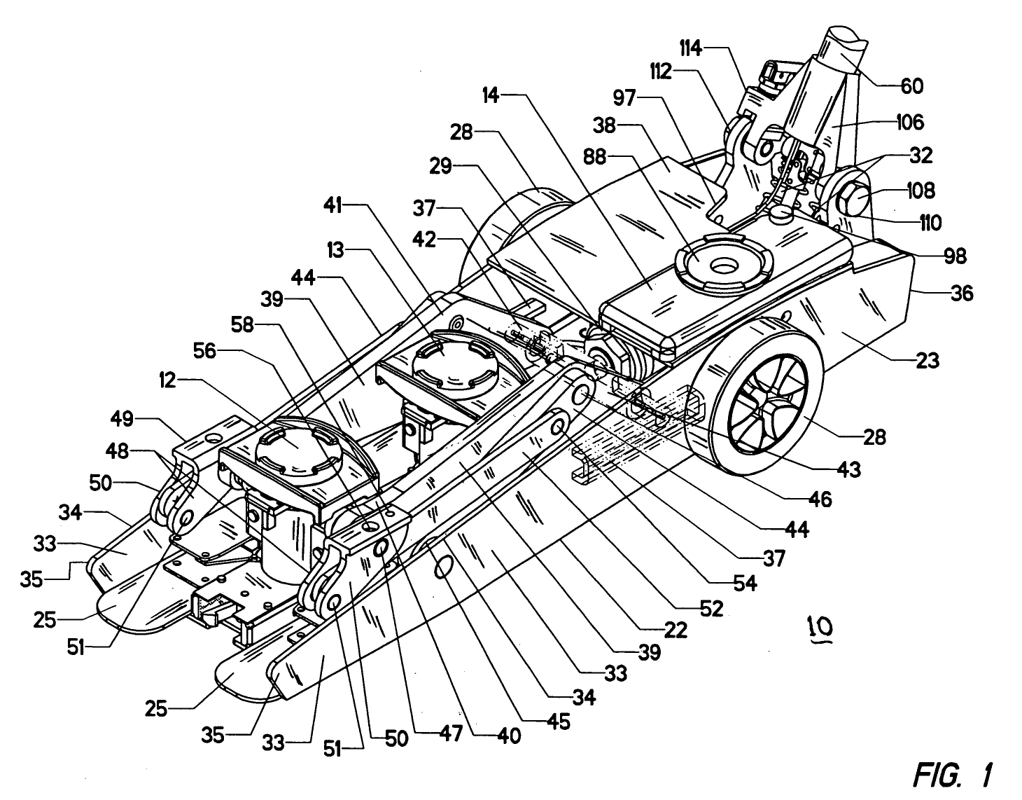

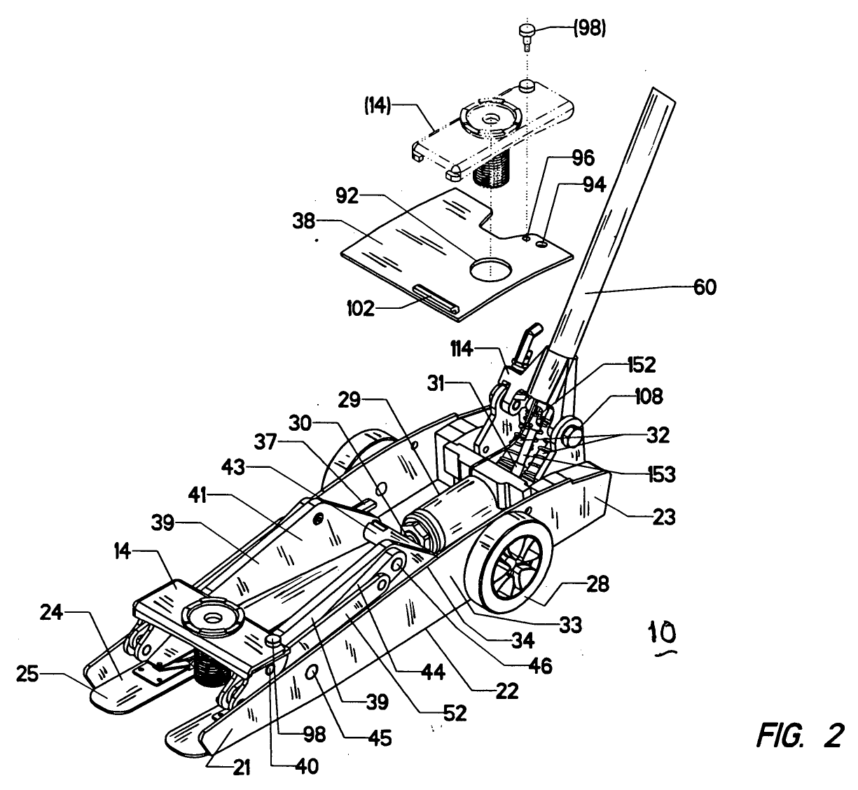

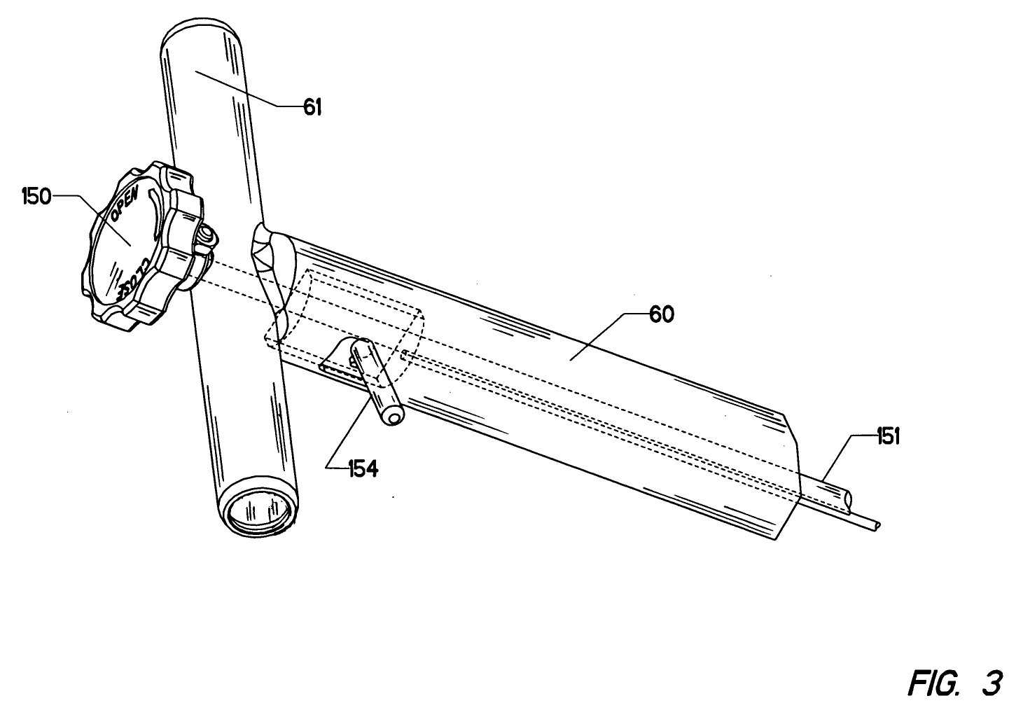

Referring first to FIGS. 1-3, there is illustrated a mobile power unit 10 for conventional use with one or more jack stands 12 and 13 for lifting and supporting a load. The power unit is also readily convertible for use directly as a load lifting jack by a manual two-position lift bridge 14 of the present invention. The lift bridge as shown in FIG. 1 is placed on the power unit in its first (stored) position, and can be manually placed into its second (operative) position, as shown in FIG. 2, on the forward end of the power unit to convert the power unit for use directly as a load-lifting jack.

The power unit 10 has a generally rectangular frame 20 having a central longitudinal axis, a forward end 21 for loading and unloading the jack stands, a middle portion 22 for securing the lifting mechanism, a rearward end 23 for controlling the power unit, and a bottom 24 thereof. The bottom has a pair of horizontal rounded-nose extensions 25 (also forming a rectangular opening between them) for engaging the jack stands.

The bottom of the frame further has the forward end 21 thereof substantially flat for providing a solid lifting platform, and has the middle portion and rearward end thereof angled longitudinally upwardly for facilitating mobility of the power unit by a pair of wheels 28 located near the rearward end 23 of the frame.

A hydraulic cylinder 29 (see FIG. 2) having an extendable ram 30 at the forward end thereof and having a rotatable control valve 31 at the rearward end thereof, is attached along the longitudinal center near the rearward end 23 of the bottom of the frame. The hydraulic cylinder preferably utilizes dual-piston type actuators 32 having a first piston actuator for rapidly extending the ram with only a few strokes, until a load exceeding about 150 pounds is encountered; the second piston actuator then takes over to extend the ram (i.e. to lift the load) in the conventional manner.

The frame has a pair of longitudinal side flanges 33 extending upward from the bottom thereof, and has the pair of wheels 28 attached to the outer sides of the flanges on lateral axels near the rearward end 23 thereof. Each side flange has an upper edge 34 with a rounded vertical nose 35 at the forward end 21 thereof and a smooth generally vertical blunted tail 36 at the rearward end thereof and has a smooth arcuate contour extending upwardly from the rounded nose to about the height of the wheels and then downwardly mating with the blunted tail, providing an attractive appearance for the frame of the power unit. Each flange further includes a U-shaped longitudinal retaining channel 37 facing inwardly and attached horizontally along the inner sides of the middle portion thereof.

The rearward end 23 of the frame includes a generally rectangular cover plate 38 that extends over and along the upper edges 34 of the side flanges 33 and covers the hydraulic cylinder 29 and some of the control mechanism. The cover plate is contoured to match the upper edge of the side flanges, and provides some protection for some of the components and a clean appearance for the rear of the power unit 10.

The power unit includes the pair of lift arms 39 that act in parallel and have forward ends 40, middle portions 41 and rearward ends 42. The lift arms are interconnected at the rearward ends thereof by a lateral push bar 43, with the respective ends of the push bar slidably retained (in suitable pivotal bushings) within the respective retaining channel 37 of the flanges; and the forward ends of the lift arms extend toward the forward end 21 of the frame.

A pair of connecting arms 44 act in parallel and have forward ends 45 and rearward ends 46, have the respective forward end pivotally connected (at 45) near the forward end of the respective flange of the frame 20. The respective rearward end is pivotally connected (at 46) on the middle portion 41 of the respective lift arm 39.

The hydraulic cylinder 29 has the ram 30 at the forward end thereof attached to the center of the lateral push bar 43. When the ram is extended, the push bar and the rearward ends 42 of the lift arms 39 are translated forward along the retaining channels 37 in the flanges of the frame, and the forward ends 40 of the lift arms are thereby raised (in scissor-like fashion with connecting arms 44).

The forward ends 40 of the lift arm 39 have also a pair of leveling pads 47 acting in parallel and are pivotally attached to the outer sides thereof (through suitable bushings and fasteners), for providing a level platform thereon for supporting the lift bridge 14. Each leveling pad includes a vertical rectangular plate having a first lever arm 48 extending downward and forwardly at an angle from the plate, and with the plate having an upper flange 49 extending horizontally therefrom, providing a level platform thereon. The platform has another flange extending vertically downward and forwardly therefrom forming a second parallel lever arm 50 thereon. The first and second lever arms having mating lateral apertures 51 in the forward ends thereof.

The leveling pads 47 utilize a pair of leveling links 52 that have a forward end 53 connected to the apertures 51 at the forward ends of the lever arm of the leveling pad, and have a rearward end 54 connected to a point (at 54) on the connecting arm 44; so that as the forward ends of lift arms 39 are raised and lowered, the platforms formed by the upper flanges 49 of the leveling pads are maintained in a substantially horizontal orientation. The leveling pads, with the double lever arms and leveling links, provide a strong, rugged level platform for use with the lift bridge 14.

One of the horizontal flanges 49 (the left one in the present example) has a vertical aperture 56 therein for retaining one side of the lift bridge. This flange further has a threaded vertical aperture 58 therein for securing one side of the lift bridge. The threaded aperture can be form into the flange with a conventional die, or can be provided by securing a suitable nut on the underside of the flange.

A tubular operating handle 60 typically extends rearward and upwardly from the rearward end 23 of the frame of the power unit 10. The tubular handle has a yoke 106 at the distal end thereof having a pair of lateral axels 108 pivotally attached within a left side bracket 110 and a right side bracket 112 with suitable bushings and fasteners. The position and operating range of the handle is manually controlled by a mechanism 114 located on the right side of the yoke.

The tubular handle 60 has a T-bar hand grip 61 transversely attached to the proximal end thereof; and further has a control knob 150 secured to a rotatable control shaft 151. The control shaft 151 extends through the tubular handle with the distal end thereof connected to a universal joint 152 so that the center of the u-joint is precisely between the lateral axels 108; and the other end of the u-joint is interconnected through a suitable coupling shaft 153 to the rotatable control valve 31 on the hydraulic cylinder. The handle also includes a control lever 154 for controlling the inter-engagement and the cooperative action of the power unit and the jack stand 12.

The operating handle 60 is used in the conventional manner for maneuvering the power unit about on its wheels, operating the hydraulic control valve, and to be pumped up and down for providing energy to actuate the hydraulic cylinder.

Handle Control Knob with Automatic Return

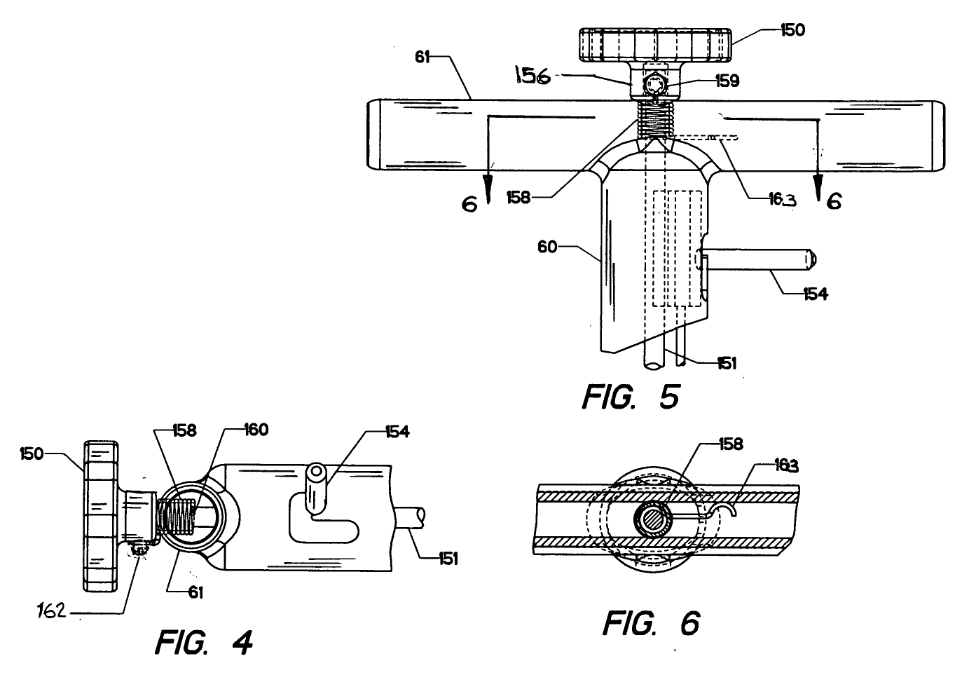

Referring also to FIGS. 4-6, a preferred embodiment of the present invention is shown including the handle control knob 150 and means for automatically biasing the knob to return to the closed position. The control valve 31 of the hydraulic cylinder 29 is typically closed with a clockwise rotation, and is opened or released with a counter-clockwise rotation, although the present invention can be adapted to the converse rotations.

The control knob 150 has an integral hub 156 that is securely attached to the control shaft 151. A cylindrical wire torsion spring 158 has an upper coil with a looped end 159 bent upward and fixed (with a suitable fastening means) to the hub of the control knob, and the lower coil has an end 160 fixed to the tubular handle (with a suitable fastening means). Thereby, the knob can be manually rotated (about one-quarter turn or more) in the counter-clockwise direction to open the valve; and when the knob is released, the torsion, spring automatically forces the knob and control shaft to rotate back in the clockwise direction to close the valve.

In the present example of this embodiment, the upper coil of the cylindrical spring 158 has the looped end 159 fastened to the hub with a suitable screw 162, and the lower coil has an extended lateral tang 163 that extends within (and is secured in position by) the wall of the inner T-bar hand grip 61. The lower coil can otherwise be secured with a suitable fastener to fix the lower end of the cylindrical spring to the tubular handle.

The upper end 159 and the lower end 160 of the cylindrical torsion spring are designed and oriented so that the control knob 150 is pre-loaded with sufficient torsional force to ensure that the control valve 31 of the hydraulic cylinder is normally securely biased into the closed position. Also, It has been found that only about one-quarter turn of the control knob is sufficient to open the control valve to lower the load; however, the torsion spring allows several complete revolutions of the control knob if needed; and when released, then fully returns the control knob and valve to the closed position.

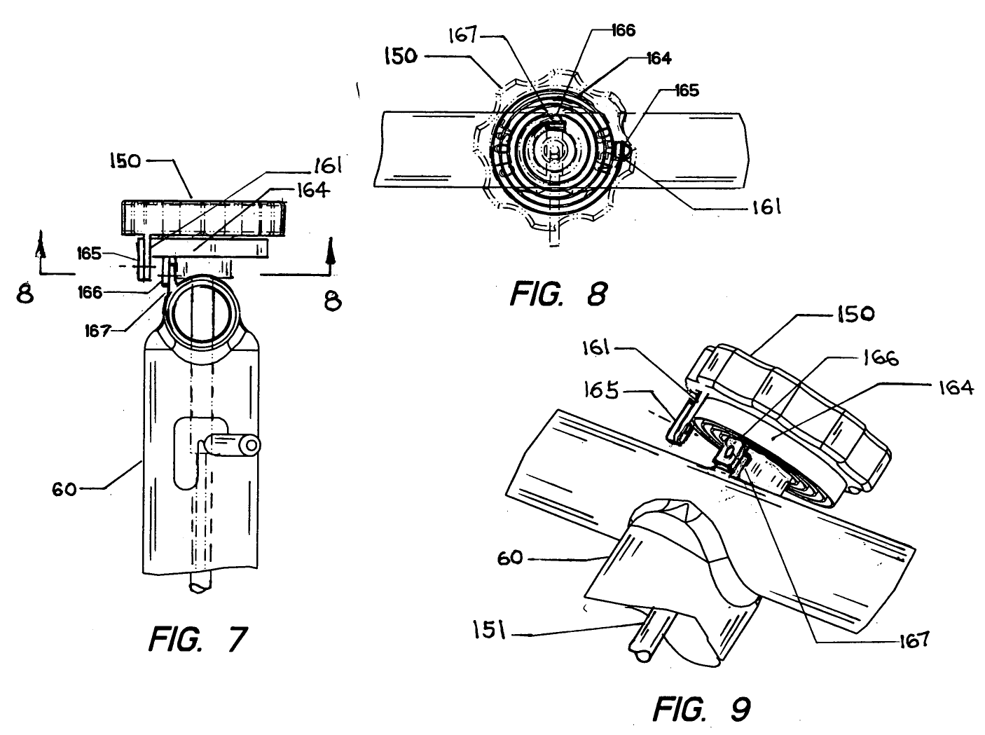

Referring to FIGS. 7-9 a second embodiment is shown, wherein the biasing means includes a spiral-leaf-clock-type torsion spring 164 having an inner end with a downward tab 166 thereon fixed to a small flange 171 extending upward from T-bar hand grip of the tubular handle 60. The spiral spring has an outer end with a downward tab 165 thereon fixed to a small flange 167 extending downward from the control knob 150. The downward tabs of the ends of the spiral springs are attached to the respective small flanges of control knob and the tubular handle with suitable screw fasteners (fasteners not shown to better illustrate the tabs and flanges). Thereby, the knob can be manually rotated (about one-quarter turn or more) in the counter-clockwise direction to open the valve; and when the knob is released, the torsion spring 164 automatically forces the knob and control shaft to rotate back in the clockwise direction to close the valve.

As previously discussed in reference to the cylindrical torsion spring, the outer end 165 and the inner end 166 of the spiral torsion spring 164 are designed and oriented so that the control knob 150 is pre-loaded with sufficient torsional force to ensure that the control valve of the cylinder is normally securely biased into the closed position. The spiral torsion spring similarly allows several complete revolutions of the control knob, if needed; and then when released, fully returns the control knob and valve to the closed position.

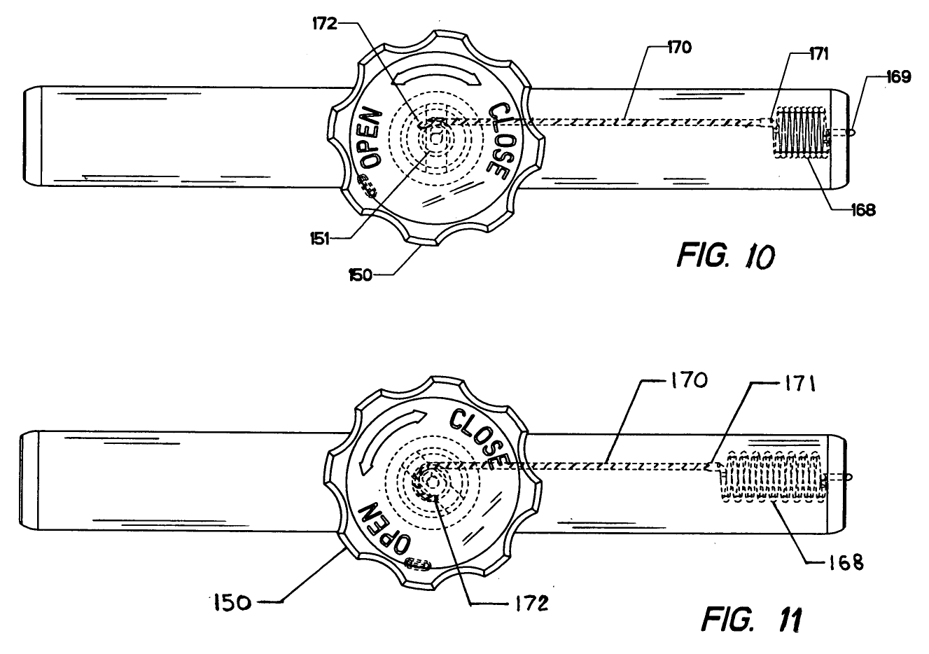

Referring to FIGS. 10 and 11 another embodiment is shown, wherein the biasing means includes a tension spring 168 having an outer end 169 connected within the T-bar hand grip 61 of the tubular handle, and having a flexible cable 170 connected to an inner end 171 of the tension spring and having the other end 172 of the cable connected to the control shaft 151, so that the control knob 150 can be rotated in the counter-clockwise direction (one-quarter turn or more) to release the control valve; and the cable winds around the control shaft to further extend the tension spring. When the control knob is released, the tension spring automatically forces the control knob and control shaft to rotate back to the clockwise direction to close the valve.

Various other combinations of springs and elastomeric compounds can be utilized to sufficiently bias the control knob to return to the closed position.

The foregoing embodiments of a handle control knob with automatic return, is very efficient in the operation of a power unit or a hydraulic floor jack. But more importantly, if the knob is accidentally bumped or released in the raised position, the automatic return immediately re-closes the valve and the load only falls a short distance, rather than falling completely down.

It is concluded that the present invention provides a control knob for a hydraulic power unit, and a hydraulic floor jack, that is always in the operable position; and an improved control knob that can be manually rotated to open the control valve, and that automatically returns the control knob to the original position to securely close the control valve.

While specific embodiments and examples of the present invention have been illustrated and described herein, it is realized that modifications and changes will occur to those skilled in the art. It is therefore to be understood that the appended claims are intended to cover all such modifications and changes as may fall within the spirit and scope of the invention.

1. A rotatable control knob with automatic return on a tubular handle for rotating a control valve of a hydraulic cylinder into a closed position, for use with a jack-stand power unit, and for use with a hydraulic floor jack, wherein the power unit and the hydraulic floor jack include a generally rectangular frame having a forward end and a rearward end thereof and a hydraulic cylinder secured at the rearward end thereof, wherein the cylinder includes at least one actuator piston thereon for extending the cylinder and the control valve thereon is rotatable in one direction for closing the valve to extend the cylinder and rotatable in a counter-direction for opening the valve to retract the cylinder; and wherein the rearward end of the frame includes the tubular handle extending rearward and upwardly therefrom with a T-bar hand grip at the proximal end thereof, with the rotatable control knob extending from the T-bar hand grip and having a distal hub connected to a control shaft extending from the control knob through the tubular handle to the control valve of the cylinder, whereby a rotation of the control knob is for rotating the control valve, wherein the automatic return includes means for biasing the control knob, the control shaft and the control valve into the closed position.

2. The rotatable control knob as defined in claim 1 wherein the biasing means includes:
a torsion spring having one end fixed to the hub of the control knob and the other end fixed to the tubular handle, so that the knob can be rotated in the counter-direction to open the valve; and when the knob is released, the torsion spring automatically forces the knob and shaft to rotate back to the original position to close the valve.

3. The rotatable control knob as defined in claim 1 wherein the biasing means includes:
a cylindrical wire torsion spring having an upper coil with the end fixed to the control knob and a lower coil with the end fixed to the tubular handle, so that the knob can be rotated in the counter-clockwise direction to open the valve; and when the knob is released, the torsion spring automatically forces the knob and shaft to rotate back to the clockwise direction to close the valve.

4. The rotatable control knob as defined in claim 1 wherein the biasing means includes:
a spiral-leaf-clock-type torsion spring having an inner end fixed to the tubular handle and an outer end fixed to the control knob, so that the knob can be rotated in the counter-clockwise direction to open the valve; and when the knob is released, the torsion spring automatically forces the knob and shaft to rotate back to the clockwise direction to close the valve.

5. The rotatable control knob as defined in claim 1 wherein the biasing means includes: a tension spring having an outer end connected within the T-bar hand grip of the tubular handle, and having a flexible cable connected to an inner end of the spring and having the other end of the cable connected to the control shaft for rotating the knob in the counter-clockwise direction for opening the valve, and for winding the cable on the control shaft extending the tension spring; and releasing the knob whereby the tension spring automatically forces the knob and shaft to rotate back to the clockwise direction to close the valve.

6. The rotatable control knob as defined in claim 1 wherein the biasing means includes a coupling shaft having one end connected to the control valve of the cylinder and having the other end connected through a universal-joint to the control shaft.
